(19) United States
(12) Patent Application Publication
(10) Pub. No.: US 2003/0038807 A1
(43) Pub. Date: Feb. 27, 2003

(54) Method and apparatus for providing computer-compatible fully synchronized audio/video information

(76) Inventors: Gary Alfred Demos, Culver City, CA (US); Peter Spoer, Burbank, CA (US)

Correspondence Address: Martin J. Jaquez, Esq., JAQUEZ & ASSOCIATES, Suite 2640, 750 B Street, San Diego, CA, 92101, US

(21) Appl. No.: 10/226,696

(22) Filed: Aug. 22, 2002

Related U.S. Application Data
(60) Provisional application No. 60/314,349, filed on Aug. 22, 2001.

(51) Int. Cl. G06T 13/00

(52) U.S. Cl. 345/473

(57) ABSTRACT

An inventive display and input method and apparatus providing fully synchronized audio/video information for use with computers and for display on computer-compatible monitors is described. The inventive display and input system includes a computer interface, and provides synchronized digital video and audio input, as well as synchronized digital and analog audio/video output. The display and input system provides synchronization of moving images for display on 72 Hz and 75 Hz computer-compatible monitors. The inventive display and input system facilitates 72 Hz and 75 Hz display of synchronized moving images, such as 24 fps tripled on 72 Hz computer-monitor displays, without using frame dropping or tearing techniques. In accordance with one aspect of the present invention, a “triple-repeat” method (of 24 fps and 25 fps video) is used to provide synchronized display onto 72 Hz and 75 Hz displays, respectively. A “double-repeat” method is used to provide synchronized display of 36 fps and 37.5 fps images on 72 Hz and 75 Hz displays, respectively.

### CROSS-REFERENCE TO RELATED PROVISIONAL APPLICATION

This application claims the benefit under 35 U.S.C. §119(e) of pending U.S. Provisional Application No. 60/314,349, filed Aug. 22, 2001, entitled “Synchronized Display and Input System for Computers”, hereby incorporated by reference herein in its entirety.

### BACKGROUND OF THE INVENTION

1. Field of the Invention

This invention relates to the field of audio/video signal processing, and more particularly to a method and apparatus for inputting and displaying fully synchronized audio/video information for use by computers.

2. Description of Related Art

In 1973, Gary Demos (a co-inventor of the present invention), working together with others, designed the first modern computer display and input system. This system was called a “frame buffer”, and it comprised a number of digital and analog input and output ports, one of the digital in-and-out ports being a computer (in this case a PDP-11 from Digital Equipment Corporation). This system was the very first use of dynamic random access memories (DRAM's), even prior to their use in computers (which at that time used magnetic “Core” memories). This frame buffer also incorporated a digital video lookup table to adjust colors prior to digital-to-analog (DAC) conversion for RGB display. This concept would eventually be embodied in chips known as “RAMDAC's” a decade later.

This first “frame buffer” system had multiple memory ports for the DRAM containing the image. This “frame buffer” had a digital video input, digital and analog video outputs, and the computer input and output ports. A computer interface signal from the control interface of the “frame buffer” indicated each frame display's completion, and could therefore be used to synchronize the image update with the display refresh, for small windows in the display (since the computer at that time was not fast enough to update the entire screen in real time).

Another feature of this “frame buffer” was its ability to zoom the image by integral pixel replication, and then pan on the image via adjusting the starting scan address. This feature could also be used to play short (lower resolution) movies which fit within memory, by updating the starting scan address to each frame in a sequence of frames upon detection of the scan completion signal.

The initial system was limited to 8-bits per pixel, allowing only a total of 256 colors. In 1974, further research and design was performed on the original Frame Buffer concept. Gary Demos' original design was modified by others, and a first modified frame buffer system was delivered to the University of Utah. This modified design was modified further to support three sections of 8-bits each, allowing the first “frame buffer” implementation of 24-bit RGB color. This system was delivered in 1975 to members of the New York Institute of Technology. A number of other units were delivered to other influential facilities and people, including employees of Jet Propulsion Laboratories (JPL), and employees of Ampex.

Gary Demos became one of a few central figures in the development of the field of computer graphics. The early frame buffer systems became important tools in the development of this field, and were highly influential with respect to subsequent display and input system designs. The images made with the early frame buffer designs were seen around the world in hundreds of presentations made between 1975 and 1980.

In 1978, Gary Demos worked with employees of Information International to develop the first high resolution 1000-line frame buffer computer display system. This frame buffer doubled the resolution of the original “frame buffer” system, extending the video image resolution to well above that of video systems, into the realm of “high definition”. This display was one of the very first high definition system components created, and it was interfaced to a computer. The display system may be considered as the very first embodiment of a high definition computer display system.

In 1980, while in collaboration with digital video design experts employed by Information International, Gary Demos designed the first digital high-speed cross-color correction system as part of a digital film printer. The digital film printer was capable of performing generalized color transformations, including the matrix transform subset. This system utilized 12-bit color precision on each of the three (usually red, green, and blue) color components. These systems became the first embodiments of the computer display and input system technology which is now ubiquitous in all personal and professional computer systems.

During the past few years a convergence, or integration, of disparate and previously incompatible multi-media information types has taken place. For example, in recent years, integration of video information for use with computers and computing peripherals has received considerable attention. Due to the massive memory and processing requirements required by video, video and still image compression techniques have been developed to facilitate the storage and processing of this information by computers. However, as is well known, because of inherent incompatibilities in the signal formats of computer graphics and source video information (such as, for example, film or television video information), the integration of video information for use with computers has proven difficult and expensive.

Digital video processing equipment, such as digital television receivers (DTVs), must be capable of inputting and displaying myriad types of source video information having different spatial and temporal resolution characteristics, and using different scanning formats. As is well known, most analog video sources use an interlaced video display format wherein each frame is scanned out as two fields that are separated temporally and offset spatially in the vertical direction. Although some variations exist, the well-known NTSC video format (used throughout the U.S. and Japan) has a field refresh rate of 60 Hz (actually 59.94 Hz) interlaced. In Europe and elsewhere, PAL and SECAM color composite video signals have a field refresh rate of 50 Hz interlaced. Motion pictures are predominantly produced using a 24 frame per second rate. However, in countries using the PAL standard, motion pictures use a 25 fps rate.

In addition, several High Definition Television (HDTV) formats have been developed for the display of high resolution television information. HDTV standards have been proposed using 60 Hz interlaced fields, while others have been proposed using 60 Hz progressively scanned images (i.e., non-interlaced). Varying aspect ratios and horizontal/vertical display resolutions have also been proposed. For example, as described in the Society of Motion Picture and Television Engineers (SMPTE) Standard, SMPTE 292M, entitled “Bit-Serial Digital Interface for High-Definition Television Systems”, published in 1995 by the SMPTE and incorporated in its entirety herein by reference, several high definition formats are utilized by modern digital video equipment. The SMPTE 292M high definition digital interface and its variants utilize a 74.25 MHz pixel clock to carry a YUV (also referred to herein as YCrCb) (half horizontal U and V resolution) digital 10-bit video signal for several high definition formats. These formats include 1920 (horizontal)×540 (vertical) resolution interlaced fields at 60 fields per second, 1920 (horizontal)×1080 (vertical) at 24 frames per second (“fps”), and 1280 (horizontal)×720 (vertical) at 60 fps.

Adding to the difficulty of providing video information for use with computers is the fact that computer monitors typically provide a much higher resolution than do conventional television monitors. Computer monitors are typically progressively scanned (i.e., non-interlaced) and use relatively high scan refresh. Most computer-type monitors are capable of displaying a wide range of refresh rates from 60 Hz upward. However, relatively high refresh rates (typically exceeding 70 Hz) are used to avoid the well-known “flicker” effects and eyestrain that occurs when 60 Hz refresh rates are used.

Many attempts have been made during the recent past to incorporate audio and video information into the personal computer and workstation environment. Due to the inherent incompatibility of the different information types, this integration typically has required several processing steps, with trade-offs in video quality, cost, functionality, power, etc. The problems associated with providing video information for use with computers are well documented as exemplified by a text entitled “Video Demystified”, written by Keith Jack, and published in 1993 by Hightext Publications, Inc., Solana Beach, Calif. (referred to hereafter as “the Jack text”). The Jack text is incorporated by reference in their entirety herein for their teachings on video image processing.

Exemplary prior art attempts at providing video information for use with computers are disclosed in the following U.S. patents: U.S. Pat. No. 6,118,486 (issued to Reitmeier on Sep. 12, 2000 for “Synchronized Multiple Format Video Processing Method and Apparatus”); and U.S. Pat. No. 6,222,589 (issued to Faroudja, et al., on Apr. 24, 2001 for “Displaying Video on High-Resolution Computer-Type Monitors Substantially without Motion Discontinuities”). Both exemplary prior art U.S. patents are incorporated herein by reference in their entirety for their teachings on video image processing. As described in the incorporated references, different digital imaging techniques and systems have been proposed facilitating the use of video imagery in computers. The digital imaging systems vary in terms of complexity, design, functions, etc. Due to the variations in digital imaging systems, proposals have been made in efforts to standardize digital video processor designs and digital video interfaces.

For example, in the early 1990s, after receiving input from industry experts, the SMPTE promulgated recommendations regarding the design of digital imaging systems. More specifically, the SMPTE generated a report of a task force on “Digital Image Architecture” describing architectural principles for designing digital moving image systems. Gary Demos was a co-editor and part author of this report. Among the highlights of this report was a recommendation that 72 Hz displays be considered for the presentation of 24 fps film material. The SMPTE report noted that 72 Hz display refresh rates produce much less flicker than do 60 Hz display refresh rates used in NTSC television systems, and is therefore more suitable for computer-compatible display of moving images. The SMPTE report also noted that 75 Hz display refresh rates be considered for PAL (50 Hz) countries, which show film at 25 fps. Although most computer display systems which used Cathode Ray Tube (CRT) displays had increased their display refresh rates to exceed 60 Hz to reduce flicker, the SMPTE task force report recommendation of increasing the display rates represented a departure from previous television system display rates.

Although the SMPTE report recommended 72 Hz (for 24 fps film material) and 75 Hz (for 25 fps film material) display refresh rates for the presentation of video images, it provided no guidance regarding implementation of an image display and input system that would accommodate the recommended display rates. Nor is there any description in the prior art that teaches or suggests a computer-compatible image display and input system that provides computer-compatible fully synchronized video and audio information at the recommended display rates.

As is well known, the prior art approach of displaying video information on computer-type monitors typically involved dropping or repeating frames because the computer-type monitor screen refresh rate is not synchronized with the image update rate. However, a problem with the prior art techniques has been that, in the absence of special processing, video signals displayed on computer-type monitors can have psycho-visually disturbing motion discontinuities due to the differences in the source video and monitor frame rates. As is well known, and as described in the incorporated Jack text, “tearing” of a video image can occur when the frame rate of a video source is not synchronized to a graphics display. Video frame buffers are usually doubled-buffered to implement simple frame-rate conversion and avoid tearing of the video picture. Simple inexpensive techniques of displaying video information on computer-type monitors can result in degradation of picture resolution and in the production of intermittent double images (or dropped images) that may be visible. Techniques causing fewer disturbing processing artifacts, such as frame interpolation, are typically very complex and expensive to implement.

Therefore, a need exists for a method and apparatus that overcomes the disadvantages associated with the prior art techniques and provides fully synchronized audio/video information for use with computers and for display on computer-compatible monitors. A need exists for a display and input system that includes a computer interface, and that provides synchronized digital video and audio input, as well as synchronized digital and analog audio/video output. In addition to providing fully synchronized audio/video output at the common television display rates of 50 Hz and 60 Hz interlaced and non-interlaced, the display and input system should provide synchronization of moving images for display on 72 Hz and 75 Hz computer-compatible monitors. The display and input system should facilitate 72 Hz and 75 Hz display of synchronized moving images, such as 24 fps tripled on 72 Hz computer-monitor displays, without using the prior art frame dropping, uneven (intermittent) frame repeating, or tearing techniques.

The present invention provides such a method and apparatus for inputting and displaying fully synchronized audio/video information for use by computers.

### SUMMARY OF THE INVENTION

An inventive display and input method and apparatus providing fully synchronized audio/video information for use with computers and for display on computer-compatible monitors is described. The inventive display and input system includes a computer interface, and provides synchronized digital video and audio input, as well as synchronized digital and analog audio/video output. In addition to providing fully synchronized audio/video output at the common television display rates of 50 Hz and 60 Hz interlaced and non-interlaced, the display and input system provides synchronization of moving images for display on 72 Hz and 75 Hz computer-compatible monitors. The inventive display and input system facilitates 72 Hz and 75 Hz display of synchronized moving images, such as 24 fps tripled on 72 Hz computer-monitor displays, without using frame dropping, uneven frame repeating, or tearing techniques. By taking advantage of unused bandwidth available in the blanking intervals used by existing interfaces, the inventive display and input system permits increases in resolution capacity of 24 and 25 fps images using existing interfaces.

One embodiment of the present display and input system uses a frame buffer memory for the storage of video frames. In one exemplary embodiment, the buffer memory is organized as a “FIFO-of-frames” (or “FIFO-of-display buffers”), wherein video frames are input to the frame buffer memory on a first in, first out basis. In this embodiment, the unit of buffering used by the buffer memory comprises a video frame. In this embodiment, a relatively large number of video frames can be stored in the frame buffer. As long as two or more frames can be stored within the buffer memory, automatic display synchronization with respect to image frame rates can be achieved.

In accordance with one aspect of the present invention, a “triple-repeat” method (of 24 fps and 25 fps video) is used to provide synchronized display onto 72 Hz and 75 Hz displays, respectively. In accordance with this method, the triple-repeat of video frames (stored within the frame buffer memory) allows 24 fps images to be synchronized with display refresh rates. This synchronization is achieved by the present inventive system with very little computer interaction. In accordance with this inventive aspect of the invention, selected frames are thrice repeated (i.e., selected frames are output from the frame buffer memory) during frame buffer memory accesses. The triple-repeat of video frames is automatically controlled by the inventive display and input system. Thus, a computer need only interact with the inventive system via a single buffer request for each frame at the 24 fps frame rate. Similarly, for 36 fps and 37.5 fps video, a “double-repeat” of a given frame stored within the frame buffer is automatically controlled by the display system. The “double-repeat” method is used to provide synchronized display of 36 fps and 37.5 fps images on 72 Hz and 75 Hz displays, respectively.

In one embodiment, existing horizontal blanking intervals are reduced to provide increased frame rates and increased pixel counts of images conveyed on digital interfaces. For example, in accordance with one aspect of the present invention, a 1280 (pixels) horizontal by 720 (lines) vertical formatted digital image is provided at 72 fps using a standard digital video interface. In another embodiment, instead of reducing the horizontal blanking intervals (also referred to as the “retrace time”), the pixel and data rate clocks are proportionally increased to produce 72 fps and 75 fps video formats. In yet another embodiment of the present invention, pixel and data rate clocks are reduced by a 1000/1001 reduction factor to support compatibility with legacy NTSC and other 59.94 Hz video systems.

The inventive display and input system ensures full synchronization of both digital and analog audio/video information. In one embodiment, the present inventive display and input system supports digital and analog video inputs having one of two selected synchronization modes. In a first video input synchronization mode supported by the present invention, the analog or digital video source devices input a video input data rate to the inventive system. In a second video input synchronization mode, the present inventive display and input system outputs the data rate signal to the video source devices. In both cases, the display and input system ensures synchronization by interlocking the external data rate and pixel rate clocks to internally-generated clocking signals. One exemplary clock synchronization method makes use of well-known phase-locked loop techniques that lock the external and internal clocks to one another. Alternative clock synchronization techniques may be used to practice the present invention.

The details of the preferred and alternative embodiments of the present invention are set forth in the accompanying drawings and the description below. Once the details of the invention are known, numerous additional innovations and changes will become obvious to one skilled in the art.

### BRIEF DESCRIPTION OF THE DRAWINGS

FIG. 1 shows a block diagram of an exemplary embodiment of a fully synchronized display and input system made in accordance with the present invention.

FIG. 2 shows a block diagram of an exemplary implementation of the fully synchronized display and input system of FIG. 1.

Like reference numbers and designations in the various drawings indicate like elements.

### DETAILED DESCRIPTION OF THE INVENTION

Throughout this description, the preferred embodiment and examples shown should be considered as exemplars, rather than as limitations on the present invention.

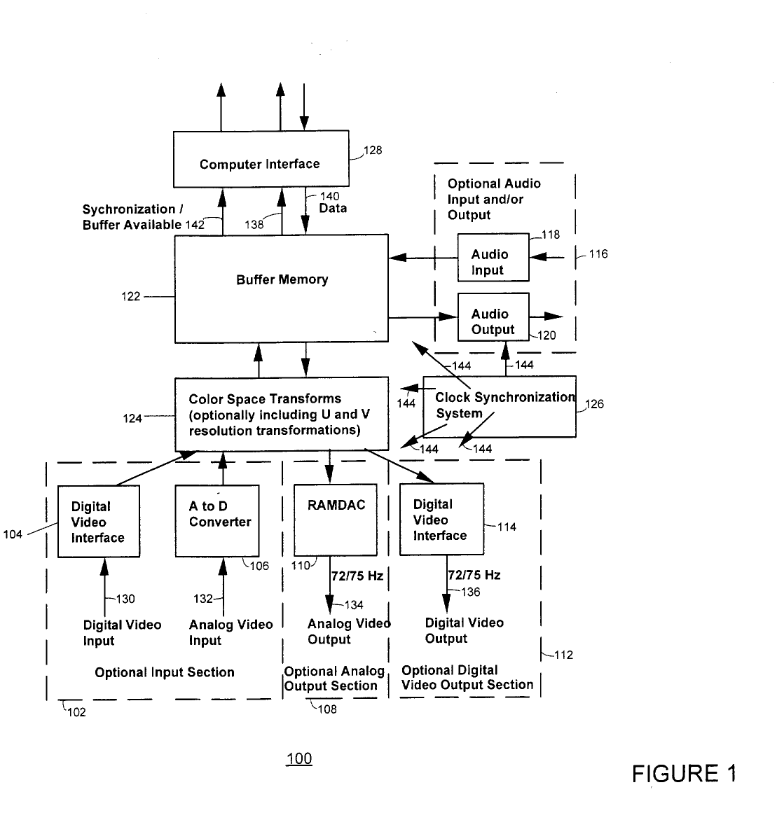

FIG. 1 shows a block diagram of one exemplary embodiment of a fully synchronized display and input system 100 made in accordance with the present invention. As described below in more detail, in addition to performing other important functions, the inventive display and input system 100 facilitates the display of synchronized moving images at display refresh rates of 72 Hz and 75 Hz without frame dropping or tearing. The inventive display and output system also ensures that the audio is fully synchronized with associated video. As described in more detail below, the display and input system 100 provides synchronized 24 fps images and audio for display on 72 Hz displays (i.e., 24 fps tripled on 72 Hz displays). The inventive display and input system 100 similarly provides synchronized 25 fps images and audio for display on 75 Hz displays. The 72 Hz and 75 Hz moving image and audio information is computer compatible and therefore accessible by a computer (or other digital processing device) via a digital interface. Other frame rates are also accommodated by the present inventive system 100. For example, moving images at 36 fps and 37.5 fps are synchronized by the system 100 and displayed on 72 Hz and 75 Hz displays. The synchronized audio/video information may be output for display to a computer-type monitor or other display device.

Referring now to FIG. 1, in one exemplary embodiment, the synchronized display and input system 100 includes the following video interfaces: an optional video input block 102 including a digital video input interface 104 and analog-to-digital (A/D) converter 106, an optional analog video output block 108 including a random access memory digital-to-analog converter (RAMDAC) 110, and an optional digital video output block 112 including a digital video output interface 114. The exemplary embodiment 100 also includes an optional audio input/output 116 comprising an audio input block 118 and an audio output block 120. The exemplary synchronized display and input system 100 also includes a buffer memory 122, a color space transform block 124, and a clock synchronization system 126 including clock synchronization circuitry. The inventive display and input system 100 also includes a computer interface 128. The computer interface permits access to the buffer memory 122 by a computer (not shown).

Each of the blocks of the exemplary display and input system 100 shown in FIG. 1 is briefly described below in separate sections. A description of how the various components shown in FIG. 1 function together to implement the inventive aspects of the synchronized display and input system of the present invention follows the description of the various components.

Optional Digital Video Input

As shown in FIG. 1, the exemplary synchronized display and input system 100 includes an optional digital and analog video input block 102. The optional video input block 102 includes an optional digital video input interface 104 and an optional analog video interface comprising an A/D converter block 106. Any well-known digital video interface may be used in implementing the digital video input interface 104. As shown in FIG. 1, digital video is input to the system 100 via a digital video input 130.

In one embodiment, the digital video input interface 104 accommodates digital component video inputs using separate color components, such as YCrCb or RGB. In one embodiment, the digital video input 130 receives digital video conforming to the incorporated SMPTE 292M Bit-Serial Digital Interface standard. Although some embodiments of the present invention are described below with reference to the incorporated SMPTE 292M standard, it will be understood that the scope of the present invention is not limited to use with any particular digital interface, and that the present inventive display and input system can be used with any convenient or useful digital video interface.

In one embodiment of the present invention, the system 100 derives a clock signal from the digital video input 130 in order to permit the contemporaneous display of video and audio information while the video information is being input to the system 100. Alternatively, the digital video input 130 may be buffered into the system 100 without display on a display device. In this case, as long as all video information is acquired from the digital video input 130 without any loss of data, the system 100 does not require locking to the incoming digital video input data clock.

Optional Analog Video Input—A/D Converter

As shown in FIG. 1, analog video information may also be optionally input to the system 100 via the A/D converter block 106. The A/D converter block 106 is capable of receiving any of the well-known analog video input signals including RGB, YCrCb, YC (also known as S-video), for example. The A/D converter block 106 may be implemented using any commercially available ADCs capable of digitizing analog video information. In one embodiment, the A/D converter block 106 is capable of sampling at rates of 10 to 150 million samples per second (MSPS). In accordance with one aspect of the present invention, and as described in more detail below, the system 100 generates a harmonic of the horizontal scan rate when inputting analog video. In one embodiment, as described in more detail below, the horizontal scan rate harmonic is produced using a harmonic phase locked loop (PLL) circuit. A pixel clock signal is thereby derived from the horizontal scan rate harmonic and used by the A/D converter block 106 when sampling analog video input to the A/D converter block 106 via an analog video input 132.

Analog Video Output

The inventive synchronized display and input system 100 of FIG. 1 optionally includes an analog video output block 108 including a RAMDAC 110. The RAMDAC 110 can be implemented using any well-known commercially available RAMDAC device (or RAMDAC functional block of a device). The RAMDAC 110 converts digital pixel values of video images stored within the buffer memory 122 into an analog video output signal. As shown in FIG. 1, the analog video output is provided at an analog video output 134. In one embodiment of the present invention, the RAMDAC 110 adds an additional modification of the video transfer function, which is often a gamma curve, in order to change the curve representation of pixel values with respect to brightness or color. However, unlike the video transfer function adjustments available within the color space transform system 124 (described below in more detail), the RAMDAC does not provide for cross-color terms.

The optional analog video output block 108 also provides the horizontal and vertical sync pulses at the analog video output 134. As is well known, the horizontal and vertical sync pulses are required for the display of analog video images. For example, in an NTSC television system, a horizontal sync pulse is transmitted for each horizontal line to keep horizontal scanning synchronized. Similarly, the vertical sync pulse is transmitted for each field to synchronize the vertical scanning motion. The synchronizing pulses are typically transmitted as part of the picture signal but are sent during the blanking periods when no picture information is transmitted. In the embodiment shown in FIG. 1, the horizontal and vertical sync pulses are typically derived as sub-multiples of the pixel clock. In one embodiment, these pulses are produced by the clock synchronization system 126 (described in more detail below) and output via the analog video output 134.

As described below in more detail, in one embodiment of the present invention, the video vertical rate is 72 Hz, 75 Hz, or their 1000/1001 variants. The picture update rate may comprise 24, 36, or 72 frames per second, or 25, 37.5, or 75 frames per second, or the 1000/1001 variants of these picture update rates.

Digital Video Output Interface

As noted above, the exemplary embodiment of the synchronized display and input system 100 of FIG. 1 optionally includes a digital video output block 112 having a digital video output interface 114. The optional digital video output block 112 provides a digital video output signal on digital video output 136. The digital video output signal carries digital video data for input to a digital video processing, storage, or display device (not shown). The digital video output 136 may conform to any convenient digital video interface specification. For example, the digital video output 136 may be interfaced to a device that accepts Digital Video Interactive (DVI) digitally-formatted data. As another example, the digital video output 136 may conform to the above-incorporated SMPTE 292M Bit-Serial Digital Interface for High-Definition Television Systems standard. As noted above, although the present invention is described with reference to the incorporated SMPTE 292M standard, it will be understood that the scope of the present invention is not limited to use with any particular digital video interface.

In some embodiments, the digital video output interface 114 outputs a digital video output 136 having a video frame rate of either 72 or 75 frames per second. In addition, as described below in more detail, the digital video output 136 may use a video frame rate of 72*1000/1001 Hz, or 75*1000/1001 (in order to provide synchronization with the NTSC television standard). The digital video output 136 can be used for display with display devices that accept digital video signals. The digital video output 136 can be provided as input to other useful digital video devices such as recorders, switchers, processors, and any other useful device that processes or stores digital video information.

As is well known, and as described in the incorporated SMPTE 292M standard, digital video interfaces typically transmit a pixel clock together with the actual pixel data values. Although the pixel clock of some display and digital video processing devices may differ from the digital video interface clock, the clocks typically are locked to one another.

Audio Input/Output

In one embodiment, the inventive display and input system 100 includes an optional audio input/output (I/O) block 116 including an audio input block 118 and an audio output block 120. The audio I/O block 116 provides a mechanism for inputting (and outputting) audio information to (or from) the system 100. The audio may be analog or digital.

As described in more detail below, the present inventive synchronized audio/video display and input system 100 ensures that audio information is fully synchronized with its associated video information. If the audio and video are in a digital format, synchronization is achieved by requiring that the audio and video clocks be locked to one another. If a digital interface conforming to the above-incorporated SMPTE 292M standard is used (which is capable of transmitting embedded audio in some formats), the digital audio and video information may be input from the same digital interface. However, if separate digital interfaces are used to generate the digital audio and video information, the separate audio and video pixel sample clocks are interlocked at the audio/video source. For example, when a high definition formatted display is used, such as, for example, a 1280 (pixels) by 720 (lines) 72 fps video display, the SMPTE 292M standard does not have room to accommodate embedded audio in this format. Therefore, separate digital interfaces are required for the digital audio and video information, and the audio and video sample clocks are interlocked at the audio/video source. Alternatively, the audio and video sample clocks are interlocked via a clock ladder in the present inventive input system.

When analog audio is used, the audio sample rate with digital video input is derived using an audio input clock. The audio input clock is derived by the system 100 from the digital video pixel or input rate. When analog audio is used together with an analog video input (wherein the video is provided via the analog video input 132 described above), the system 100 uses a pixel clock, which is derived from the horizontal scanline rate signal, to synchronize the audio information with the video information. In one embodiment, the pixel clock is derived as a phase-locked-loop harmonic of the horizontal scanline rate and is used as the source of the derived analog audio. When digital audio is used together with analog video, the pixel clock is derived as a harmonic of the horizontal video rate. The video sample rate is thereby ensured to be locked to the digital audio sample rate.

Optional Color Space Transforms

As is well known and as described in the incorporated Jack text, color information can be digitally represented using color spaces. Color spaces comprise mathematical representations of color information. Many color spaces can be used in practicing the present invention, including RGB, YIQ, YUV, Hue Saturation Luminance (HSL), Hue Saturation Value (HSV), Luminance u′ v′, and others. The Color Space Transform (CST) block 124 optionally performs input color space transformations on incoming video (input to the system 100 via the video input block 102) before it is stored in the buffer memory 122. On output, the CST block 124 optionally performs output color space transformation of the stored digital video information before it is output via either the RAMDAC 110 (i.e., analog video) or the digital video output interface 114 (i.e., digital video). The CST block is “optional” because in some operating modes, the CST block 124 performs no color space transformation on the digital video information, but rather simply passes the video information through (on input to the frame buffer memory, and on output to either the RAMDAC 110 or the digital video output interface 114).

An exemplary input color space transformation performed by the CST block 124 transforms RGB color space to YUV color space. Alternatively, the CST block 124 transforms the YUV color space to RGB. As is well known in the digital video processing arts, in the YUV color space, it is typical to reduce the U and V chroma resolution either horizontally, vertically, or both vertically and horizontally. The U and V chroma resolution is usually reduced in half, although other reduction ratios can be used in practicing the present invention. The reduction of chroma resolution reduces 0.25 both the memory bandwidth and size requirements associated with the buffer memory 122. The CST 124 also alternatively performs color space transformations from a first set of RGB primaries to a second set of RGB primaries. As is well known, the incorporated SMPTE 292M standard supports YUV having half horizontal resolution in U and V in a single-link mode (i.e., when a single SMPTE 292M serial digital interface is used for the I/O of digital video). In this case, the color space transform block 124 converts the YUV format to (or from) RGB within the buffer memory 122. When a dual-link mode is used (i.e., when a “dual-link” SMPTE 292M serial digital interface is used for the I/O of digital video), full resolution U and V, as well as full resolution RGB, are also supported by the system 100. RGB plus Alpha color spaces can also be supported to provide a composite matte signal for production input applications.

An exemplary output color space transformation performed by the CST block 124 transforms YUV color space to RGB color space. Such a color space transformation is particularly useful because most computer-type display devices utilize RGB signals. In addition, when performing the YUV to RGB color space transformation, the CST block 124 optionally increases chroma resolution in U and V. The increase in chroma resolution may be performed vertically, horizontally, or both horizontally and vertically. Many other color space transformations are possible. For example, in one embodiment, as noted above, the CST 124 may perform RGB to RGB color space transformations. Such transformations may be useful when using video displays or video output devices that require color primaries other than those used by the RGB pixels stored within the buffer memory 122. Also, when processing SMPTE 292M formatted video (or other digital video standards that operate using YUV formats), the CST 124 can be used to convert from RGB (or other formats) to the digital YUV format needed by the digital video output interface block 112 (or for storage in the frame buffer memory 122).

In addition to performing input and output color space transformations, the CST 124 can also change the video transfer function. As is well known, the video transfer function often comprises a gamma curve. The CST 124 can modify the video transfer function in order to change the curve representation of pixel values with respect to brightness and color. Within the color space transform block 124, such optional curve modifications can have optional cross-color terms (also known as a color matrix).

Clock Synchronization System

As shown in the exemplary embodiment of FIG. 1, the present inventive synchronized display and input system 100 includes a clock synchronization system 126. In one embodiment, the clock synchronization system 126 comprises circuitry including phase lock loops (PLL) that synchronize the various video pixel and audio sample clocks. The phase lock loops may be implemented in hardware, software, or a combination of both hardware and software. As described in more detail below, clocking signals, such as the horizontal scan rate, frame rate, and vertical scan rate signals, are derived from a pixel clock. An internal pixel clock is also provided. In one exemplary embodiment, an internal 1.485 Gbit/second reference data clock is provided and used to derive other internal clocks used by the system 100.

However, those skilled in the digital video and audio processing arts shall recognize that other convenient reference clocks can be used without departing from the scope or spirit of the present invention. The internal pixel clock is used when there is no external video input (i.e., when there is no incoming video signal provided at the digital video input 130). As described in more detail below, the internal pixel clock generated by the clock synchronization system 126 is used when video is displayed or output via the analog (134) or digital (130) video outputs and when not simultaneously inputting video. In other related embodiments, pixel clock rates such as 74.25 MHz or the related 89.1 MHz may be used as the internal reference.

The clock synchronization system 126 communicates with other components of the inventive system 100 to provide the internal clocking signals to the various processing blocks. For example, as shown in FIG. 1, the clock synchronization system 126 provides clocking signals to the optional audio I/O block 116, the buffer memory 122, the CST 124, and the video output blocks 108, 112 via a plurality of clock/control lines 144. Details regarding the inventive aspects of the clock synchronization system 126 are described below in more detail with regard to the description of synchronization (by the inventive system 100) to video (and audio) input and output devices.

Buffer Memory

The buffer memory 122 stores frames of digital video in a selected color space. In one embodiment, the color space is determined by the color space transform system 124 for use with video I/O. In another embodiment, the color space used in storing the video information within the buffer memory 122 is selected by a computing device (not shown) that interfaces with the system 100 via a computer interface 128.

Any convenient number of video frames can be stored within the buffer memory 122.

The size of the buffer memory varies in accordance with system requirements. In one embodiment, the memory 122 is structured as a “First-In, First-Out” (FIFO) memory, wherein the input and output of the buffer memory 122 are independently clocked. An exemplary embodiment of the buffer memory 122 uses the well-known “ring buffer” organization. Alternatively, any other suitable or convenient buffer memory organization can be used to implement the FIFO buffer memory structure. In one embodiment, the buffer memory comprises 128 Mbytes, although larger and smaller memory sizes can be used to practice the present invention.

In one exemplary embodiment of the present inventive display and input system 100, the buffer memory 122 is organized as a “FIFO-of-frames” or “FIFO-of-display buffers”, wherein video frames are input to the buffer memory 122 on a first-in, first out basis. In this embodiment, the unit of buffering used by the buffer memory 122 comprises a video frame (possibly also including associated audio as described below in more detail). In this embodiment, a relatively large number of frames can be stored in the FIFO frame memory (for example, approximately 50 frames can be stored at 1280×720 resolution using YUV formatting, with half U and V horizontal resolution). As described below in more detail, as long as two or more frames can be stored within the buffer memory's FIFO configuration, automatic display synchronization with respect to image frame rates can be achieved.

The FIFO organization (and independent I/O clocking) of the buffer memory 122 ensures that variations in the rate of computer-implemented digital video processing does not adversely affect the display of images stored in the buffer memory 122. Stated in another way, the FIFO organization (and independent I/O clocking) used to implement the buffer memory 122 provides timing “slack” to the computing device (or devices) coupled to the computer interface 128. The timing slack allows the system 100 to support multiple digital video processing functions. The time required to perform each digital video processing function varies depending on the function. As is well known in the digital video processing arts, variations in digital video processing timing are due to many common processing variables inherent to computer video processing software. Using the FIFO-structured buffer memory 122, and independent I/O clocking of the memory, these video processing variations do not degrade synchronization performance of the inventive display and input system 100. Nor do they adversely affect the display of video information stored in the memory 122.

Use of a large number of frames aids in smoothing variations in the frame transfer rate from the computer. For example, when playing images from a disk system (such as, for example, a RAID disk array), the FIFO-of-frames buffer memory 122 can mask disk seek latencies that are occasionally required. In addition, the FIFO frame memory aids in smoothing variations in the time required to decode each frame during realtime-synchronized decompression. Some frames (such as, for example, I or B frames) may take longer to decompress than do other frames. It is valuable to be able to mask these occasionally slower frames or sections of frames using a sufficiently large buffer memory 122. In this manner, perfect synchronization of moving image displays is maintained over arbitrarily long time periods.

In one embodiment of the present inventive display and input system 100, the entire buffer memory 122 is dedicated for digital video input (i.e., the entire buffer memory 122 is dedicated to inputting digital video, either from the digital video input interface 104 or the A/D converter 106), and for outputting the stored digital video frames upon request to a computing device (via the computer interface 128). Alternatively, the buffer memory 122 is dedicated for video output only (i.e., the entire buffer memory 122 is dedicated for outputting digital video, either through the digital video output interface 114 or the RAMDAC 110). In yet another embodiment, the buffer memory 122 is partitioned into two sections, which can be equal or unequal in size, one for the input of video frames, and the other for the output of video frames.

Computer Interface

As shown in FIG. 1, digitized video data is exchanged between a computing device (not shown) coupled to the computer interface 128 using the data bus lines 138 (output data bus) and 140 (input data bus). In one embodiment of the present invention, the computer interface comprises the well-known 64-bit PCI-Bus interface. However, this computer interface is exemplary only and is not meant to limit the scope of the present invention. Those skilled in the digital processing and computing arts shall recognize that any convenient and suitable computer interface can be used to practice the present invention, provided that the interface supports required video data transfer rates, and provided that the interface supports required control registers and data clocks.

As shown in FIG. 1, a synchronization flag control signal is provided as input to the computer interface 128, and as input to the computing device (not shown), via a control signal line 142. The synchronization flag control signal indicates availability of the buffer memory 122 (as described above) to the computing device. Buffer availability indication is provided for each of the input and output functions of the buffer memory 122. Buffer availability indication and display synchronization techniques are now described in the following section.

Display (Output) Buffering and Synchronization

In one embodiment of the present invention, display synchronization with respect to image frame rates is achieved by utilizing two or more buffered frames or frame buffers, and using an automated hold-off system for accessing the frame buffers. When frame buffers are available, images are loaded into the buffer memory 122 as the images are made available by a computer (not shown in FIG. 1). However, when all of the frame buffers are full, which occurs when active synchronized display (possibly including “repeat frame displays” described below in more detail) of the images is still in progress for the frame buffer that would be available next, the system 100 signals the computer using the synchronization flag (via control line 142) that no frame buffer is currently available.

When the computer is signaled that no frame buffer is currently available, the computer either waits until a frame buffer is available, or it performs other tasks. In accordance with this aspect of the present invention, the computer waits until the inventive display and input system 100 signals the computer (either via an interrupt signal (such as the synchronization flag) or via a status register that is accessible to the computer via the computer interface 128) that the display of the needed frame is complete, and that the associated frame buffer (previously used to store the displayed frame) is therefore available for use by the computer.

As described below in more detail, one embodiment of the present invention uses a “triple-repeat” method (of 24 fps and 25 fps video) to provide synchronized display onto 72 Hz and 75 Hz displays, respectively. The use of triple-repeat of a frame within the buffer memory 122 allows 24 fps images to be synchronized with the display refresh rate with a minimum of computer interaction. The triple-repeat method is automatically controlled by the display system 100. Thus, the computer need only interact with the display system via a single buffer request for each frame at the 24 fps frame rate. Similarly, for 36 fps (and 37.5) fps video, a “double-repeat” of a frame within a frame buffer is automatically controlled by the display system 100. Consequently, computer interaction need only occur when a frame buffer is requested at the 36 fps rate. The inventive frame repetition method is described in more detail below in a separate section.

Input Buffering and Synchronization

As with output synchronization, the present inventive display and input system 100 uses the FIFO-structured buffer memory 122 to synchronize input of video data to the computer (coupled to the computer interface 128). As described below in more detail, input synchronization between the system 100 and the computer is based upon the availability of frame buffers in the buffer memory 122. As noted above, in one embodiment, the buffer memory 122 uses a FIFO-of-frames configuration. In this configuration, the buffer memory 122 is organized into buffered frames (also referred to herein as “frame buffers”), wherein the buffered frames or frame buffers are accessible on a First-In, First-Out basis, and wherein the buffered frames each contain one frame of digital video information.

Similar to the synchronization mechanism described above with reference to output buffering, if the computer's video frame input rate exceeds the display and input system's video data rate (i.e., the rate at which the present inventive display and input system 100 stores video frames in the buffer memory 122), the display and input system 100 signals the computer that a buffered frame is not yet available. When the next requested input buffered frame is completely received by the display and input system 100 and stored within the buffer memory 122, the system 100 signals the computer that the requested buffered frame is available for input. The inventive display and input system 100 signals the computer via the computer interface 128 described above with reference to FIG. 1.

In one embodiment, the system 100 signals the computer that the requested buffered frame is available for input using an interrupt signal. Additionally, or alternatively, the system 100 signals the computer that the requested buffered frame is available for input to the computer by setting a status bit in a register (or flip-flop device) accessible to the computer via the computer interface 128. As long as the buffer memory 122 is capable of holding at least two video frames, the computer can transfer video frames from a first frame buffer while the display and input system 100 inputs the next video frame to a second frame buffer. If many frame buffers are available in the buffer memory 122, variations in the computer's ability to accept or process the video frames can be smoothed so that synchronization between the computer and the inventive system 100 is maintained.

In one exemplary embodiment, as described above, the buffer memory 122 comprises 128 Mbytes of FIFO-organized frame memory. In one embodiment of the present inventive system 100, as noted above, the entire buffer memory is dedicated to display (or output) of the video frames stored in the buffer memory 122. Alternatively, the buffer memory 122 can be dedicated to input of video frames (sourced from the optional video input block 102, for example). In yet another embodiment, the buffer memory 122 is partitioned and shared between input and display (output) of digital video. When the buffer memory 122 is partitioned (for example, partitioned with half of the buffer memory 122 dedicated for input buffering, and half for output buffering), computer video processing can be performed on the input video stream while the same input video stream (or another selected video stream, or a processed version of the selected input video stream) is contemporaneously output (and/or displayed). The flexible use of a large buffer memory 122 is beneficial in allowing computer systems to support synchronized input, synchronized output and/or display, or both simultaneous input and output (or display) of video images.

Having described the various component blocks shown in FIG. 1, a description of how the various components function together to implement the inventive synchronized display and input system is now provided. As described below in more detail, the present inventive method and apparatus provides a facility for achieving 72 Hz and 75 Hz computer display, on the input, output, of synchronized moving images, such as 24 fps tripled on a 72 Hz display, and 25 fps tripled on a 75 Hz display, without frame dropping or tearing of the moving images. The inventive method and apparatus also provides fully synchronized audio (wherein the audio information is fully synchronized with associated video). Fully synchronized 72 Hz and 75 Hz video/audio information is stored in the buffer memory 122 for output (on a display device and/or audio device) and/or input to a computing device. In another aspect of the present inventive method and apparatus, improvements in resolution capacity of 24 fps video are made using unused available bandwidth present in the blanking intervals of existing digital video interfaces. Other aspects and features of the present inventive method and apparatus are described below.

Reducing SMPTE 292M Horizontal Blanking Intervals to Yield 72 Hz Synchronized Frame Displays

In one embodiment of the present invention, existing horizontal blanking intervals are reduced to provide increased frame rates and increased pixel counts of images stored within the inventive system 100. For example, in accordance with one aspect of the present invention, a 1280 (pixels) horizontal by 720 (lines) vertical formatted digital image is conveyed at 72 fps using an SMPTE 292M digital video interface.

As described in the above-incorporated SMPTE 292M high definition (HD) digital interface standard, the HDTV digital interface (and its variants) transmit and receive YUV (half horizontal U and V resolution) 10-bit digital video signals for several HD formats. These HD formats include 1920 horizontal×540 vertical resolution interlaced fields at 60 fps, 1920 horizontal×1080 vertical at 24 fps, and 1280 horizontal×720 vertical at 60 fps. In one embodiment of the present invention, the digital image stored within the FIFO-of-frames buffer memory 122 conforms to the proposed SMPTE 296M standard entitled “1280×720 Scanning, Analog and Digital Representation and Analog Interface”, published by the SMPTE for comments, and incorporated herein by reference for its teachings on high resolution image formats. As described in the incorporated SMPTE 296M standard, a family of raster scanning systems exists for the representation of stationary or moving two-dimensional, images sampled temporally at a constant frame rate and having an image format of 1280×720 and an aspect ratio of 16:9. In addition to other aspects, the standard specifies R′G′B′ encoding, R′G′B′ analog and digital representation, Y′P′_{B}P′_{R} color encoding (also known as YUV) (including analog representation and analog interface), Y′C′_{B}C′_{R} color encoding (also known as YUV), digital representation and digital interface.

As described in the incorporated SMPTE standards, the digital interface and its variants use a 74.25 MHz pixel clock to transmit and receive the YUV digital video signals. As described below in more detail, both active pixel and blanking interval data are transceived via the digital interface. As a consequence, bandwidth is available for the transmission of additional active video information within the otherwise unused blanking interval. In accordance with one aspect, this available additional bandwidth is used by the present inventive synchronized display and input method and apparatus to increase the frame rate or pixel counts of the above-identified formats. The present inventive method and apparatus uses a higher proportion of available sample times to convey active pixel information.

More specifically, the incorporated SMPTE 296M standard defines how a 1280×720 formatted video image at 60 fps is provided over a bit-serial interface conforming to the incorporated SMPTE 292 standard. As defined by the incorporated references, the 74.25 MHz pixel clock transmits 1650 total pixels×750 total lines. The 1650×750 “image” includes both active pixels and blanking information (both vertical and horizontal blanking). The following horizontal timing pattern is defined in the incorporated standard: horiz_front_porch=70 pixels, horiz_sync_width=40 pixels, horiz_back_porch=260 pixels, and horiz_active_pixels=1280 pixels. Therefore, the total horizontal pixel information transmitted by the 74.25 MHz pixel clock is 70+40+260+1280, or 1,650 pixels, which includes both active pixels and horizontal blanking information.

The following vertical timing pattern is defined in the incorporated standard: vert_front_porch=5, vert_sync_width=5, vert_back_porch=20, and vert_active_lines=720 lines. Thus, the total vertical line information transmitted by the pixel clock is 5+5+20+720, or 750 total vertical lines. Similar to the horizontal pixel information, the vertical line information includes both active lines and blanking information. Thus, the SMPTE standard blanking intervals comprise 370 horizontal blanking pixels [1650 (total pixels transmitted over the interface)−1280 (active horizontal pixels)] and 30 vertical blanking lines [750 (total lines)−720 (active lines)].

In one embodiment, the present inventive display and input system reduces the horizontal blanking interval (i.e., the number of pixels assigned to the horizontal blanking information) to provide a 72 fps 1280×720 video image via a SMPTE 292M-comforming digital interface. The present invention uses the above-described “excess” blanking information inherent to the SMPTE standard to convey additional active pixel information, via the interface. The present invention reduces the number of horizontal blanking pixels clocked across the digital interface, and uses the available pixel clocks to convey active pixels.

For example, in one application of the inventive horizontal blanking interval reduction technique, the present inventive system 100 uses 1375 total pixels (horizontal) by 750 total lines, at the 74.25 MHz pixel rate, to produce 1280×720 72 fps digital video. In this embodiment, when 1375 total pixels are used, the blanking interval is reduced from 370 to 95 pixels (i.e., the blanking interval comprises 1375 (total horizontal pixels)−1280 (active horizontal pixels)=95 pixels). More specifically, the present invention uses the following horizontal timing pattern (having reduced horizontal blanking intervals) using a 74.25 MHz pixel clock to transceive 1280×720 72 fps video: horiz_front_porch=5, horiz_sync_width=38, horiz_back_porch=52, and horiz_active_pixels=1,280 (total horizontal pixels). Thus, the total horizontal pixels transmitted by the 74.25 MHz pixel clock is 5+38+52+1,280, or 1,375. In this embodiment, the vertical timing pattern is identical to the vertical timing pattern described above with reference to the SMPTE standard (i.e., comprising 750 total lines and 30 lines for providing vertical blanking information).

The horizontal blanking intervals are thereby advantageously reduced to relatively short durations using the inventive method and apparatus. The reductions to the horizontal blanking interval permits an existing SMPTE 292M bit-serial digital interface to be used when transceiving 1280×720 72 fps video information. The reduced horizontal blanking durations are acceptable for display by most digital displays and some digital cameras. However, the reduced blanking durations may be incompatible with some commercially available analog displays requiring retrace, such as the common Cathode Ray Tube (CRT) displays. Any analog monitor that is capable of accepting the inventive reduced horizontal sync signals can display the 74.25 MHz formatted digital signal. As is well known, some analog cameras also utilize longer retrace times and therefore might be incompatible with the present inventive method and apparatus.

As will be appreciated by those skilled in the computing and video processing arts, the reductions in blanking pixels given above are exemplary only, and should not be interpreted as limiting the scope or spirit of the present inventive method and apparatus. The present invention contemplates use of any convenient and useful blanking interval, and any reduction of the blanking intervals for purposes of providing 72 fps digital video via a bit-serial interface falls within the scope of the present invention.

Increasing Pixel and Data Clocks to Yield 72 Hz and 75 Hz Synchronized Frame Displays

In another embodiment of the present invention, instead of shortening the horizontal blanking intervals (also referred to as the “retrace time”), the pixel and data rate clocks are proportionally increased, (including the normal generous retrace times) to produce the desired 72 fps and 75 fps video formats. For example, in one embodiment, the 74.25 MHz pixel clock is increased by a factor of 72/60 (or 6/5) to produce the 1280×720 72 fps frame displays. In this embodiment, the 74.25 MHz pixel clock is increased to a frequency of 89.10 MHz. In another embodiment, the 74.25 MHz pixel clock is increased by a factor of 75/60 (or 5/4) to produce the 1280×720 75 fps frame displays. In this embodiment, the 74.25 MHz pixel clock is increased to a frequency of 92.8125 MHz.

The exemplary simple pixel clock multiplication factors (6/5 for 72 fps, and 5/4 for 75 fps) ease implementation and production of the higher pixel clocks and also permit all of the clock signals to be easily inter-locked. For example, in one embodiment as noted above, phase-locked loop circuits are used to lock the 74.25 MHz pixel clock to the increased pixel clock signals. Use of simple pixel clock multiplication factors facilitates the contemporaneous use of analog and digital video formats. Thus, analog input and display can be contemporaneously provided to the digital input and output circuits. Although the exemplary embodiment uses simple pixel clock multiplication factors, it will be appreciated and understood by those skilled in the digital video processing arts that other pixel clock multiplication factors can be used to practice the present invention, and that the present invention encompasses use of any convenient or useful pixel clock multiplication factor.

Increasing Digital Video I/O Bandwidth to Yield 72 Hz and 75 Hz Synchronized Frame Displays

Alternatively, or additionally to the techniques described above, a “dual-link” SMPTE 292M serial digital interface is used in one embodiment for the input and output of digital video. Use of an SMPTE 292M dual-link serial digital interface doubles the bandwidth and I/O capacity of the system 100 as compared to the single-link embodiment. This increased I/O bandwidth can be used by the present invention to support the 72 fps and 75 fps digital video formats described above. Further, as described above, the SMPTE 292M dual-link digital interface provides sufficient additional capacity capable of transceiving full horizontal resolution U and V, or RGB channels. Further, using the dual-link embodiment of the present display and input system 100, additional data capacity is provided that can be used to increase the pixel bit precision beyond the common 10-bit pixel color component value. For example, in some embodiments, higher pixel precision values can be used, such as 12-bit (or higher) pixel color component values.

Therefore, some embodiments of the present invention permit use of greater than 8 bits for each of R, G, and B (in RGB formats), or Y, U, and V (in YUV formats) pixel representation. In one exemplary embodiment described above, 10-bits are used for transfer on the computer interface 128, for storage in the FIFO frame memory buffer 122, for color transformations by the CST 124, for the performance of transfer-curve lookups, and for digital video output or digital-to-analog conversion for analog video output. For color transformations, the use of more than 8 bits in the computations for color space conversion (which is processed in one embodiment of the CST 124 as a matrix transform) greatly improves picture quality. Further, the use of more than 8 bits when performing color resolution filtering, such as from half-horizontal or vertical resolution to full-horizontal or vertical resolution in U and V, can also greatly improve picture quality. For example, if 6 filter taps are used for color resolution filtering, and the precision of each multiply and addition exceeds 8 bits when performing digital filtering, the result has a higher quality in terms of both purity and clarity of color.

Reduction of Pixel and Data Rate Clocks to Support Legacy NTSC Video

As is well known, it is common practice to reduce the frame rate of 24 fps video by a factor of 1000/1001 to provide compatibility with NTSC televisions. The resulting reduced frame rate video is referred to as 23.98 fps video (although, more precisely, the frame rate equals 23.976024). As is well known, NTSC televisions use a 60 Hz refresh rate reduced by the 1000/1001 factor (i.e., they operate at 59.94 (more precisely, 59.94006) Hz refresh rates). In accordance with one embodiment of the present invention, synchronization with 1000/1001 reductions to 72 Hz is provided for compatibility with such refresh rate reductions of 24 fps video. For compatibility with this scenario, 72, 36, and 24 fps can all be reduced in the system 100 using the 1000/1001 refresh rate reduction factor. As described below in more detail, if audio information comprises 48 kHz or 96 kHz associated with 23.98 fps video (rather than 24 fps video), it is sometimes desirable to retain the 23.98 frame rate for images.

The 1000/1001 rate reductions of many digital video formats are defined in the incorporated SMPTE 292M digital interface standard. In accordance with one aspect of the present invention, the desired variation in refresh rates is achieved by reducing the 74.25 MHz pixel clock and its corresponding data rate clock (which operates at 1.485 Gb/s) by the 1000/1001 refresh rate reduction factor. More specifically, in one embodiment, multiplying the 72 fps rate by the 1000/1001 reduction factor provides compatibility with the 23.98 fps image rate. This results in a video frame rate of approximately 71.928072 Hz. In one embodiment, legacy NTSC video compatibility is achieved by multiplying the 74.25 MHz pixel clock by the 1000/1001 reduction factor. This results in a pixel clock of 74.175842176 MHz. The inventive approach is described below with reference to synchronization of audio.

As described above, one embodiment of the present inventive display and input system 100 uses proportionally increased pixel and data rate clocks to produce 72 fps (and 75 fps) video. In one embodiment, the present invention applies the 1000/1001 reduction factor to the increased pixel and data rate clocks to support 59.94 Hz legacy NTSC video output compatibility. For example, as described above, in one embodiment, the 74.25 MHz pixel clock is increased by a factor of 6/5 to yield 1280×720 72 fps frame displays. In this embodiment, the 74.25 MHz pixel clock is increased to 89.10 MHz. In order to provide compatibility with 59.94 Hz legacy NTSC video, one embodiment of the present invention multiplies the resultant increased pixel clock (e.g., the 89.10 MHz pixel clock) by the 1000/1001 reduction factor.

Increased Image Resolution

Another embodiment of the present invention utilizes unused data bandwidth present in the incorporated SMPTE 292M retrace interval to increase the image resolution of 24 and 25 fps video images. This embodiment extends the 1920 (horizontal)×1080 (vertical) image at 24 fps and 25 fps up to 2560 (horizontal)×1080 (vertical) and 2048 (horizontal)×1280 (vertical). For example, the total pixels generated by the digital video interface for 1920×1080 formatted images at 24 fps on SMPTE 292M operating at 74.25 MHz is 2750 horizontal (pixels) by 1125 vertical (lines). Thus, the horizontal blanking interval used in transmitting 1920×1080 images comprises 830 pixels (2750 total pixels−1920 active pixels).

This blanking interval is far too large to be useful. Indeed, such a generous blanking interval is wasteful, because 1920×1080 video is intended for use with 30 Hz refresh rates, where the total pixels comprises 2200, and the horizontal blanking is therefore 280 pixels (2200 total pixels−1920 active pixels). Thus, within the 2750 total pixels used in transmitting 1920×1080 formatted images at 24 fps, 2560 pixels can easily be accommodated. Further, 2048×1280 video images at 24 fps can be accommodated using SMPTE 292M interfaces having a 74.25 MHz pixel clock by using 2250 total pixels horizontally by 1350 total lines. The factorization of the 74.25 MHz pixel clock, (the pixel clock defined in the incorporated SMPTE 292M digital interface) comprises 2⁴*3³* 5⁶*11. In one embodiment of the present invention, the total pixel and line counts are derived using this collection of multiplication factors. Thus, resolution may be substantially increased at 24 fps utilizing these and other common digital interfaces for high definition video.

Frame Repetition for Synchronized Output on 72 Hz and 75 Hz Displays

One embodiment of the present inventive display and input system 100 includes an inventive technique for repeating frames of 24 fps and 25 fps film and video images for synchronized display on 72 Hz and 75 Hz monitors, respectively. As is well known in the video arts, 25 fps film frames are commonly repeated on both fields of 50 Hz PAL-compatible television systems. It is also common to utilize 3-2 pull-down to present 24 fps film frames on 60 Hz NTSC-like television systems. The present inventive display and input system extends these prior art techniques to provide for a “triple-repeat” of 24 fps and 25 fps film and video frames for synchronized display on 72 Hz and 75 Hz displays, respectively. One embodiment of the present inventive display and input system also applies the “double-repeat” (without the use of interlace) technique to 36 fps and 37.5 fps images for synchronized display on 72 Hz and 75 Hz displays, respectively.

Just as double and triple frame repetition (or “frame repeats”) techniques are useful, higher numbers of frame repeats can be applied to other frame rate video for synchronized display on 72 Hz and 75 Hz displays. For example, in one embodiment of the present invention, frames are repeated six times to provide 12 fps and 12.5 fps on 72 Hz and 75 Hz displays, respectively. In another embodiment, five-repeats are used to provide 12 fps on 60 Hz displays.

Although a 75 Hz display refresh rate is commonly used for computer monitors, the technology for synchronization of moving images with 75 Hz display screens has not heretofore been available for use with computers. While 72 Hz display rates on computers are less common than 75 Hz, 72 Hz provides the benefit of allowing playback at 24 fps when utilizing the methods of this invention.

In accordance with the present invention, the triple-repeat of frames within the buffer memory 122 is automatically controlled and processed by the present display and input system 100 with very little interaction required by the computer. As described above, in one embodiment, the buffer memory 122 is organized as a FIFO of video frames. In this embodiment, the computer outputs video frames (through the computer interface 128) for storage in the buffer memory at any desired rate, as long as the computer maintains an average rate that ensures that the FIFO is never emptied.

In accordance with one embodiment of the inventive triple-repeat technique, the system 100 automatically repeats output of a frame three consecutive times (i.e., contents of a given frame buffer are output to the digital output (134) or analog output (136), and displayed on a display device) before the next frame is output. This automatic frame repetition is performed by the present inventive display and input system 100 without interaction by the computer. As described above, the computer need only interact with the display system 100 via a single frame buffer request for each frame at the 24 fps frame rate. Similarly, for 36 fps (and 37.5 fps) video (accommodated using double-frame repetition), the computer only needs to interact with the display system 100 using a single frame buffer request for each frame at the 36 fps frame rate. Similarly to the triple-repetition method, the double frame repetition is performed automatically by the present inventive display and input system 100. Specifically, in this embodiment, the system 100 automatically twice repeats the output of a frame buffer (i.e., contents of a given frame buffer are output through the digital output (134) or analog output (136), and displayed on a display device) before the next frame is output.

As described above, the buffer memory 122 typically comprises a relatively large memory capable of storing a relatively large number of frames. For example, in one embodiment, as noted above, approximately 50 frames of digital video at 1280×720 resolution (using YUV formatted data with half U and V horizontal resolution) can be held by the buffer memory 122. Although smaller and larger memory sizes can be used to implement the FIFO-of-frames buffer memory 122, the buffer memory 122 should be sufficiently large to hold at least two video frames in order to accommodate the inventive automatic synchronized display of video images described in this section.

Synchronization with Digital and Analog Video and Audio Inputs

In one embodiment, the present inventive display and input system 100 supports digital and analog video inputs having one of two selected synchronization modes. In a first video input synchronization mode supported by the present inventive system 100, the analog or digital video source device (e.g., a video camera, video tape machine, or other video source device) inputs the data rate of the video input to the inventive system 100. In a second video input synchronization mode (described below in more detail), the present inventive display and input system 100 provides the data rate signal to the video source device.

When the first video input synchronization mode is used (wherein the source device inputs the data rate clocking signal to the system 100), the inventive display and input system 100 locks to the video source data rate, and generates all of its internal clock signals (including pixel, scanline, frame rate, and audio clocks) based upon the video source data rate. In one exemplary embodiment, the clock synchronization system 126 uses well-known phase-locked loop (PLL) circuits to lock to the video source data rate signal, and to generate internal clock signals (such as the pixel rate clock, frame rate clock, etc.) that are locked to the video source data rate. Input audio should be buffered to allow de-multiplexing, and should have its samples locked inside the source.

In one embodiment wherein the video input comprises digital video conforming to the incorporated SMPTE 292M digital interface standard (or similar digital interface), the system 100 uses the 1.485 Gbit/second data rate clock (defined by the SMPTE 292M standard) as the data rate clocking signal. In this embodiment, all of the audio, frame rate, and other derivative clock signals are derived from this externally provided 1.485 Gbit/second data rate clock (instead of, for example, being derived from the system's internal 1.485 Gbit/second reference data clock described above with reference to the clock synchronization system 126). As described above, the external 1.485 Gbit/second data rate clock is provided to the input system 100 via the digital video interface block 104 and the digital video input 130. As described above, the SMPTE 292M digital input carries the 74.25 MHz pixel clock utilizing a harmonic at 1.485 GHz for the serial bit clock. Thus, in the embodiment of the present invention wherein a digital video input signal is provided that conforms to the SMPTE 292M specification (and any analogous digital interface specifications), a stable digital interface clock (or set of related clocks) is used as the top of a clock ladder. The clock ladder produces all of the video clock signals used by the system 100 (for example, the pixel clock, scanline clock, frame rate clock, and audio clock signals).

When analog video inputs are provided using the first video format, the analog video sources provide horizontal and vertical synchronization (or “scan rate”) signals. In this embodiment, the system 100 (and more specifically, the clock synchronization system 126) derives a pixel clock based upon the horizontal and vertical sync signals. For example, in one embodiment, the system 100 generates the pixel clock using a phase-locked loop harmonic clock generation circuit. In another embodiment, the A/D converter 106 performs this PLL function thereby generating a digitized video signal including a pixel clock signal. Alternatively, this function can be provided by an external A/D converter (in which case a digital video signal as produced by the A/D converter, is input to the system 100). The derived pixel clock is used by the system 100 to process video frames and store (and retrieve) frames in the buffer memory 122. Phase-locked loop harmonic clock generation techniques are well known in the analog video arts. For example, in a number of analog input systems, the pixel clock is derived using a PLL tuned to a specific harmonic count of the horizontal scanline rate. For example, a flat panel display having an analog input typically generates such a clock from the horizontal sync pulses in order to clock pixels into their appropriate locations within the display. The present inventive display and input system 100 contemplates use of any of the well-known PLL harmonic clock generation techniques for purposes of deriving the pixel clock from the analog video sync signals. A weakness of using a harmonic of the horizontal rate is that clock jitter often occurs due to noise in the PLL that is tuned to the pixel harmonic. Thus, a digital video input provides a much cleaner sample clock (in addition to providing digital pixel values). This eliminates errors in A/D sample timing and errors that occur during A/D conversion.

As noted above, the present invention also supports a second video input synchronization mode wherein the display and input system 100 provides the data rate signal for use by the video source device. When this video input synchronization mode is used, the video source device (e.g., a video camera, video tape machine, or other video source device) locks to the data rate clock output by the inventive display and input system. As described below in more detail, the audio clock (via a “word clock” and Longitudinal Time Code (LTC)) is typically provided separately from the video clock in this case. Alternatively, the audio clock may be provided together with the video clock (or be derived from the video clock). This aspect of the present inventive display and input system is described in more detail below with reference to the I/O of audio information (described in the section below).

Numerous variations of the above-described clock locking techniques (i.e., wherein the clocks used internally by the inventive system are locked to clocks used by external video and audio devices) are possible. Those skilled in the audio/video processing design arts shall recognize that a myriad of clock locking techniques are possible, and that all of these techniques can be used to practice the present invention. However, to avoid loss of synchronization, no matter what specific clock locking technique is used, audio samples and frame rates should not drift with respect to incoming video streams and associated audio.

Fully Synchronized Audio

As is well known in the audio/video arts, a valuable part of most moving image sequences (i.e., video) is its associated audio information. The present inventive display and input method and apparatus provides video that is fully synchronized with associated audio information. In one embodiment, video clocks are locked to associated audio clocks. For example, in one exemplary embodiment, the video frame rate clock (used to input or output video frames) is synchronized to the audio sample rate clock using a series of dividers and phase locked loop circuits. In one embodiment, the clock synchronization system 126 implements this PLL function and thereby locks the video frame rate and audio sample rate clocks.

In one embodiment of the system 100 described above with reference to FIG. 1, the 74.25 MHz pixel clock is divided by the total number of samples per frame to produce a frame update rate. For example, in one embodiment, a pixel clock is divided by a pre-determined division factor (in one embodiment, by a division factor of 1546.875, which is equal to 12,375/8) to create a 48 kHz clock used for audio sampling. A divide circuit that performs the 12,375/16 function (divided into 74.25 MHz) can be used to generate a 96 kHz audio sampling clock. When an 89.1 MHz pixel clock is used (for example, as described above, during the production of 1280×720 72 fps video frame displays), the pixel clock is divided using a different pre-determined division factor in order to yield a 48 kHz audio sample clock. Specifically, in one embodiment, the 89.1 MHz pixel clock is divided by 1856.25 (7425/4) to produce a 48 kHz audio sample clock. In another embodiment, the 89.1 MHz pixel clock is divided by (7425/8) to produce a 96 kHz audio sample clock.

In one embodiment of the present invention, the 72 fps frame rate is divided by a factor of three to create a 24 fps sub-rate for use with commercially available digital audio devices that accept the well-known Longitudinal Time Code (LTC) used for synchronization. The combination of 48 kHz (and 96 kHz) “word clocks”, together with the 24 fps LTC, permits synchronization of commercially available digital audio tape and disk systems with the present display and input system over arbitrarily long periods of time. In addition, using this inventive method of generating a word clock (either 48 or 96 kHz), together with an LTC, allows the audio to be started exactly when the video picture begins playing or recording, thereby providing lip sync and other sound-and-picture synchronization.

In some embodiments of the present invention, the well-known digital or vertical interval time code (VITC) is used for synchronization instead of using LTC for this purpose. Also, some recently developed digital video systems provide meta-data that carries such synchronization information. However, at present, the number of commercially available devices that synchronize based upon metadata is small. Those skilled in the audio and video processing arts shall appreciate that the present invention contemplates compatibility with any of these synchronization formats and techniques.

The three displayed frames associated with each 24 fps timecode can be distinguished in a number of ways. For example, timecode userbits can be used to carry these three phase values. Also, metadata and other forms of user data can carry this information. In systems where metadata is generalized, 72 fps and 75 fps data can be directly indicated, thus facilitating development of future systems synchronized at 72 fps and 75 fps solely using metadata.

In one embodiment of the inventive display and input system, audio data that is associated with each updated frame is stored with its associated frame in the FIFO-structured buffer memory 122. For example, if 24 fps images are displayed by the system 100 at 72 Hz, 1/24 seconds of associated audio is stored in the buffer memory 122 adjacent to each associated video frame. Similarly, if 36 fps images are displayed by the system 100 at 72 Hz, 1/36 seconds of associated audio is stored in the buffer memory 122 adjacent to each associated video frame.

As is well known, it is common practice in audio systems to synchronize with the 1000/1001 ratio reduction of 60 Hz video (i.e., 59.94 Hz) for compatibility with legacy NTSC video. To achieve this synchronization, the audio is sometimes locked to 48,000 digital samples corresponding to 59.94 frames, and at other times corresponding to 60 frames. This necessitates audio re-sampling conversion in some cases to adjust for this disparity. Other known techniques, known as “drop frame”, are utilized to adjust timing and timecode marking at the end of 1000 (or 1001) frames when utilizing 59.94 Hz or when converting between 59.94 Hz and 60 Hz.

As described above, 24 fps film is sometimes adjusted by the 1000/1001 reduction factor for video output onto 59.94 Hz NTSC displays. As described above in more detail, the resultant video is commonly referred to as 23.98 video (although, more precisely, the resultant frame rate equals 23.976024 fps). If associated audio comprises 48 kHz or 96 kHz, and is associated with 23.98 fps video rather than 24.0 fps video, then it is sometimes desirable to retain the 23.98 rate for images. The present invention contemplates embodiments that retain the 23.98 fps rate for images. As described above, in one embodiment, the present invention provides compatibility with the 23.98 fps rate images using a frame rate clock having a frequency of 72* 1000/1001, or 71.928072 Hz. In one embodiment, wherein a digital interface conforming to the incorporated SMPTE 292M digital interface standard (or similar digital interface standard) is used, this is accomplished by multiplying the 74.25 MHz pixel clock by the 1000/1001 reduction factor. This produces a resultant pixel clock of 74.175842176 MHz. This technique is especially useful in eliminating a need for 48 kHz and 96 kHz audio re-sampling (for example, when 48 kHz is tied to the 23.98 fps film rate).

Pixel Replicate Zoom

In one embodiment of the present invention, a magnification or “zoom” method is available during output (or “playback”) of the digital video stored in the buffer memory 122. More specifically, in one embodiment, the inventive system 100 includes a “pixel-replicate zoom” function that provides simple magnification of video images during playback. As is well known, pixel-replicate zoom functions may be implemented by repeating pixel values that are stored in a frame buffer for a selected number of horizontal magnification pixels (thereby producing a desired horizontal magnification), and restarting at the same scanline starting address for a selected number of vertical magnification pixels (thereby producing a desired vertical magnification). Because it allows close scrutiny of moving images, the pixel replicate zoom function has proven useful for optimizing quality and refining pixel processing.

Implementation

The inventive display and input system may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions described above.

In one embodiment, the inventive display and input system is implemented by modifying existing high resolution display and input systems. For example, in one embodiment, the present invention is implemented by modifying the commercially available “HDStationPRO” family of products (including the commercially available “HDStationPRO OEM Board”, models “HSO” (single-link, YUV-422) and “HSO-DL” (dual-link, RGB-444) available from DVS Digital Video, Inc. (hereafter “DVS”), having U.S. headquarters in Glendale, Calif. Information regarding the functions performed by the HDStationPRO product family and HDStationPRO OEM Board, and specifications related thereto, may be obtained by accessing the DVS website located on the Internet (www) at “dvsus.com”. The information published at the DVS website relating to the HDStationPRO products and HDStationPRO OEM Board is incorporated herein by reference.

As described in the incorporated related provisional application and in the incorporated DVS publications, the HDStationPRO OEM Board comprises a single-slot display and input board for real-time input and output of uncompressed HDTV images. As described in the related provisional application, the HDStationPRO OEM Board display and input board (including daughter board) interfaces to a computer using a 64-bit PCI-Bus interface. The display and input board provides synchronized digital video and audio input, synchronized digital and analog video output, and digital audio output at common television formats using 50 Hz and 60 Hz interlaced and non-interlaced display.

As described in the incorporated DVS references and related provisional application, the HDStationPRO OEM Board includes field programmable circuits (e.g., field programmable gate array (FPGA) circuits). The field programmable circuits can be programmed to adjust some of the functions performed by the video processing circuitry. In one exemplary embodiment, the present invention is implemented by programming the HDStationPRO OEM Board and thereby modifying existing clock signals (and/or providing additional clock signals) to include clock frequencies and formats necessary for performing the inventive functions described above.

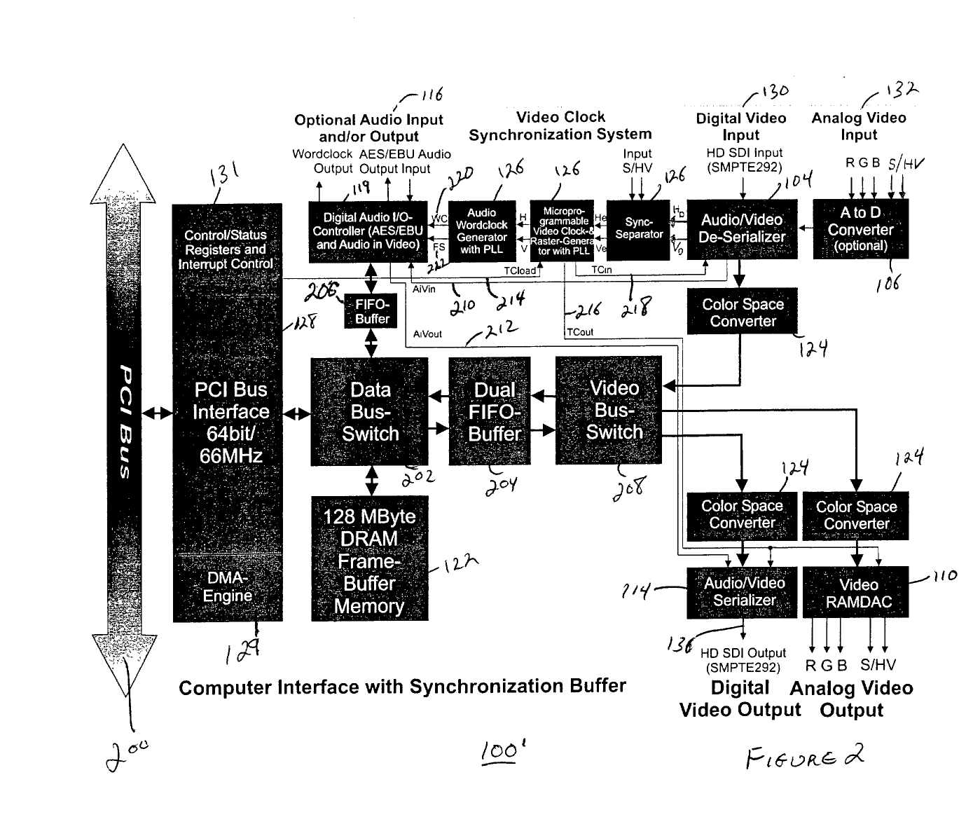

FIG. 2 shows a block diagram of one exemplary implementation 100′ of the display and input system of FIG. 1 using the HDStationPRO OEM Board. Many of the blocks shown in the exemplary implementation of FIG. 2 perform similar functions to those described above with reference to FIG. 1, and therefore are not described in more detail herein.

Similar to the display and input system described above with reference to FIG. 1, the exemplary implementation 100′ shown in FIG. 2 includes the following video interfaces: an optional video input block including a digital video input interface 104 (audio/video de-serializer) and optional analog-to-digital (A/D) converter 106, an optional analog video output block including a video RAMDAC 110, and an optional digital video output block including a digital video output interface 114 (audio/video serializer). The exemplary embodiment 100′ also includes an optional audio input/output 116. The optional audio input/output 116 includes a digital audio I/O controller 119. The exemplary implementation of the synchronized display and input system 100′ also includes a buffer memory 122, color space transform or converter blocks 124, and clock synchronization blocks 126 including clock synchronization circuitry. The implementation shown in FIG. 2 also includes a computer interface 128. The computer interface permits access to the buffer memory 122 by a computer (not shown) connected to the well known PCI bus 200. The implementation shown in FIG. 2 also includes a data bus switch 202, a dual FIFO buffer, a FIFO buffer 206, and a video bus switch 208.

As shown in FIG. 2, the computer interface 128 also includes a DMA engine 129 and control/status registers and interrupt control processing 131. The DMA engine 129 functions in a well known manner to allow direct memory access between the computer and the display and input system 100′. As described above with reference to FIG. 1, the control/status registers and interrupt control processing block 131 coordinate communications between the computer and the display and input system 100′. More specifically, as described above with reference to FIG. 1, in accordance with one aspect of the present invention, the computer waits until the inventive display and input system 100′ signals the computer that the display of a needed video frame is complete, and that an associated frame buffer is available for use by the computer. As described above, this synchronization between the computer and the inventive system 100′ is achieved using either an interrupt signal (such as a synchronization flag) or using a control/status register accessible to the computer. In the exemplary implementation 100′ of FIG. 2, this synchronization is achieved using the block 131.

The exemplary implementation shown in FIG. 2 also includes input and output embedded audio (also referred to as “Audio in Video”) signal paths. As shown in FIG. 2, an embedded input audio signal path (“AiVin”) 210 is coupled between the audio/video de-serializer 104 and the digital audio I/O controller 119. Similarly, an embedded output audio signal path (“AiVout”) 212 carries embedded output audio from the audio I/O controller 119 for input to the audio/video serializer 114.

As described above, the HDStationPRO OEM Board includes programmable circuits that can be programmed to adjust some of the functions performed by the video processing circuitry. In the exemplary implementation 100′ shown in FIG. 2, the clock synchronization system 126 includes a micro-programmable video clock and raster-generator block having PLL circuitry. As shown in FIG. 2, the system 100′ includes a control line “TCload” 214 coupled from the control/status registers and interrupt control processing block 131 to the micro-programmable video clock and raster-generator 126. The control line TCload 214 is used to load the micro-programmable clock generator with control code. As described above, the control code is used to modify existing clock signals (and/or provide additional clock signals) to include clock frequencies and formats necessary for performing the various functions of the present invention.

The exemplary implementation shown in FIG. 2 also includes two signals, TCout 216 and TCin 218, which are used to provide programmable timing control of the video input 104 and output blocks 110, 114. As shown in FIG. 2, TCout 216 is output by the micro-programmable video clock and raster generator clock synchronization block 126 and input to both the audio/video serializer 114 and the video RAMDAC 110. Similarly, TCin 218 is output by he micro-programmable video clock and raster generator clock synchronization block 126 and input to the audio/video de-serializer 104.

As shown in FIG. 2, the implementation 100′ also uses two timing signals, “WC” 220 and “FS” 222 to synchronize the audio I/O to the video timebase. Specifically, the WC 220 timing signal provides a “wordclock” signal to the digital audio I/O controller 119. The FS 222 timing signal provides a “framestart” signal to the digital audio I/O controller 119. These timing signals function similarly to the timing signals described above with reference to the display and input system 100 of FIG. 1. The implementation 100′ of FIG. 2 also includes internal horizontal and vertical video timebase signals (“H, V, He and Ve”) used by the video clock synchronization system. These signals function similarly to the analogous signals described above with reference to the system of FIG. 1.

The invention may also be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the present invention have been described. Nevertheless, it will be understood that various modifications may be made without departing from the spirit and scope of the claimed invention. For example, although some embodiments of the present inventive display and input system have been described above as using digital interfaces that conform to the SMPTE 292M digital interface standard, it will be understood that the scope of the present invention is not limited to use of this specific digital standard. Rather, the scope of the present invention encompasses any useful or convenient digital computer display interface. For example, the present invention is compatible with DVI digital. Similarly, although some embodiments have been described as using specific analog video interfaces, it will be understood that the scope of the present invention is not limited to use with the analog video formats given in the examples above. Rather, the present inventive display and input system can be used with any useful or convenient analog video format. For example, the present invention is compatible with RGB, YCrCb and YC (also known as S-video).

Further, although the description of the exemplary embodiments provided above uses exemplary digital image formats (such as, e.g., the image formats defined in the SMPTE 296M standard), it will be understood that the present inventive display and input system can accommodate any useful or convenient image format. Finally, although one described implementation of the present invention makes use of the commercially available DVS HDStationPRO product family (and more specifically, the DVS HDStationPRO OEM Board), it will be understood by those skilled in the video processing and display arts that this implementation is exemplary only. As described above, the present invention can be implemented in hardware, software, or a combination of hardware and software. Moreover, the present invention may be implemented by computer programs executed by special-purpose or general purpose computing devices, or both. Therefore, the scope of the present inventive display and input system is not limited to any of the exemplary implementations described above.

Accordingly, it is to be understood that the invention is not to be limited by the specific illustrated embodiments, but only by the scope of the appended claims.

What is claimed is:

1. A fully synchronized audio/video display and input system capable of displaying fully synchronized video on computer-compatible display monitors, comprising:
a) an optional video input/output (I/O) having a first plurality of associated video clock signals for communicating video information;
b) an optional audio I/O having a first plurality of associated audio clock signals for communicating audio information;
c) a frame buffer memory, coupled to the optional audio I/O, wherein video frames are stored within and retrieved from the frame buffer memory on a first in, first out (FIFO) basis;
d) a computer interface, adapted to interface to a computer and coupled to the frame buffer memory; and
e) a clock synchronization system adapted to receive the first plurality of video and audio clock signals, wherein the clock synchronization system generates a second plurality of video and audio clock signals used internally by the display and input system to store and retrieve audio and video information within and from the frame buffer memory;
wherein the display and input system generates fully synchronized audio and video at selected frame rates, and wherein the selected frame rates exceed 60 Hz.

2. The display and input system of claim 1, wherein video frames are accessed from the frame buffer memory on a frame by frame basis, and wherein a selected video frame is automatically displayed a pre-determined repeat number of times at a selected output video frame rate.

3. The display and input system of claim 2, wherein selected video frames are repeated three times to synchronize 24 fps video for display on a 72 Hz monitor.

4. The display and input system of claim 2, wherein selected video frames are twice repeated to synchronize 36 fps video for display on a 72 Hz monitor.

5. The display and input system of claim 2, wherein selected video frames are repeated three times to synchronize 25 fps video for display on a 75 Hz monitor.

6. The display and input system of claim 2, wherein selected video frames are twice repeated to synchronize 37.5 fps video for display on a 75 Hz monitor.

7. The system of claim 2, wherein the selected output video frame rate is reduced by a refresh rate reduction factor of 1000/1001 thereby providing compatibility with legacy NTSC monitors and other 59.94 Hz video systems.

8. The system of claim 2, wherein the selected video frames are repeated six times providing synchronization of 12 fps video with a 72 Hz monitor.

9. The system of claim 2, wherein the selected video frames are repeated six times providing synchronization of 12.5 fps video with a 75 Hz monitor.

10. The system of claim 2, wherein the selected video frames are repeated five times providing synchronization of 12 fps video with a 60 Hz monitor.

11. The system of claim 1, wherein the display and input system synchronizes the first plurality of video and audio clock signals to the second plurality of video and audio clock signals.

12. The system of claim 11, wherein the system locks the first and second plurality of video and audio clock signals to one another using phase-locked loop clock synchronization.

13. The system of claim 11, wherein the optional video I/O inputs a video data rate for use by the system, and wherein the second plurality of internally generated clock signals are derived from and synchronized with the input video data rate.

14. The system of claim 13, wherein the optional video I/O inputs a digital video signal having an associated data rate clock, and wherein the second plurality of internally generated clock signals are derived from and synchronized with the data rate clock.

15. The system of claim 13, wherein the optional video I/O inputs an analog video signal having associated horizontal and vertical synchronization signals, and wherein the second plurality of internally generated clock signals are derived from and synchronized with the horizontal and vertical synchronization signals.

16. The system of claim 15, wherein the second plurality of internally generated clock signals are derived from and synchronized with the horizontal and vertical synchronization signals using a phase-locked loop (PLL) clock generation circuit.

17. The system of claim 11, wherein audio I/O is synchronized to video I/O using a word clock.

18. The system of claim 17, wherein the display and input system generates an audio sample clock for use by an audio I/O device, wherein the audio sample clock is derived from the second plurality of video clock signals.

19. The system of claim 18, wherein the audio sample clock comprises a 48 kHz audio sample clock.

20. The system of claim 18, wherein the audio sample clock comprises a 96 kHz audio sample clock.

21. The system of claim 11, wherein audio information is stored within the frame buffer memory at a location that is logically related to its associated and respective video information.

22. The system of claim 17, wherein the audio I/O is synchronized to the video I/O using Longitudinal Time Codes (LTC) associated with a frame sub-rate derived from the video I/O, and wherein the LTC is used for synchronization of the audio with digital audio devices.

23. The system of claim 17, wherein the audio I/O is synchronized to the video I/O using Vertical Interval Time Codes (VITC).

24. The system of claim 11, wherein the audio I/O is synchronized to the video I/O using metadata.

25. The system of claim 22, wherein the video data rate comprises 72 fps, and wherein the 72 fps video data rate is divided by a factor of 3 thereby producing a 24 fps sub-rate, and wherein the LTC is synchronized to every third frame of the 72 fps video.

26. The system of claim 25, wherein video frames associated with each time code are distinguished from each other using userbits carrying phase information associated with each video frame.

27. The system of claim 25, wherein video frames associated with each time code are distinguished from each other using metadata carrying phase information associated with each video frame.

28. The system of claim 1, wherein the video information output by the display and input system through the optional video I/O comprises analog video.

29. The system of claim 28, wherein the analog video comprises RGB video.

30. The system of claim 1, wherein the video information output by the display and input system through the optional video I/O comprises digital video.

31. The system of claim 30, wherein the digital video conforms to an SMPTE 292M standard for HDTV bit-serial digital interfaces.

32. The system of claim 30, wherein the digital video comprises Digital Video Interactive (DVI) digital video.

33. The system of claim 2, wherein the frame buffer memory holds at least two video frames.

34. The system of claim 33, wherein the frame buffer memory compensates for timing variations between the computer and the display and input system.

35. The system of claim 33, wherein the frame buffer memory compensates for timing variations in preparation of video displays.

36. The system of claim 2, further comprising an optional color space transformation (CST) block operatively coupled to the optional video I/O.

37. The system of claim 1, wherein the display and input system selectively outputs the fully synchronized audio and video for display on 72 Hz and 75 Hz computer-compatible monitors.

38. The system of claim 1, wherein the display and input system selectively outputs the fully synchronized audio and video to a digital video interface.

39. The system of claim 1, wherein the display and input system selectively outputs the fully synchronized audio for input to an external analog audio device.

40. The system of claim 1, wherein the display and input system selectively outputs the fully synchronized audio for input to an external digital audio device.

41. The system of claim 31, wherein relatively high-precision pixel values are used to represent the digital video information.

42. The system of claim 41, wherein at least 8-bits are used to represent each color component of the digital video.

43. The system of claim 41, wherein 10-bits are used to represent each color component of the digital video.

44. The system of claim 41, wherein at least 12-bits are used to represent each color component of the digital video.

45. A fully synchronized audio/video display and input system capable of displaying fully synchronized video on computer-compatible display monitors, comprising:
a) means for optionally inputting and outputting (I/O) video information having a first plurality of associated video clock signals;
b) means for optionally inputting and outputting (I/O) audio having a first plurality of associated audio clock signals;
c) means, responsive to the optional audio and video I/O means, for storing video frames, wherein video frames are stored within and retrieved from the storage means on a first in, first out (FIFO) basis;
d) means, coupled to the storage means, for interfacing with a computer; and
e) means, responsive to the first plurality of video and audio clock signals, for performing clock synchronization, wherein the clock synchronization means generates a second plurality of video and audio clock signals used internally by the display and input system to store and retrieve audio and video information within and from the storage means;
wherein the display and input system generates fully synchronized audio and video at selected frame rates, and wherein the selected frame rates exceed 60 Hz.

46. The fully synchronized audio/video display and input system of claim 45, further comprising:
a) means, responsive to the optional video I/O means and coupled to the storage means, for performing color space transformations (CST) from a first color space to a second color space.

47. The system of claim 45, wherein the display and input system selectively outputs the fully synchronized audio and video for display on 72 Hz and 75 Hz computer-compatible monitors.

48. The system of claim 45, wherein the display and input system selectively outputs the fully synchronized audio and video to a digital video interface.

49. The system of claim 45, wherein the display and input system selectively outputs the fully synchronized audio for input to an external analog audio device.

50. The system of claim 45, wherein the display and input system selectively outputs the fully synchronized audio for input to an external digital audio device.

51. A method of fully synchronizing input and display of audio and video information for use with computer-compatible display monitors, comprising:
a) optionally inputting and outputting (I/O) video information having a first plurality of associated video clock signals;
b) optionally inputting and outputting (I/O) audio having a first plurality of associated audio clock signals;
c) generating a second plurality of video and audio clock signals, wherein the first and second plurality of video and audio clock signals are locked to one another;
d) accessing video frames in a storage means on a first in, first out (FIFO) basis; and
e) generating fully synchronized audio and video at selected frame rates, wherein the selected frame rates exceed 60 Hz.

52. The method of fully synchronizing input and display of audio and video information for use with computer-compatible display monitors of claim 51, further comprising:
a) optionally performing color space transformations (CST) on video information from a first color space to a second color space.

53. The method of fully synchronizing input and display of audio and video information for use with computer-compatible display monitors of claim 51, further comprising:
a) selectively displaying the fully synchronized audio and video generated in step e) on 72 Hz and 75 Hz computer-compatible monitors.

54. The method of claim 51, further comprising:
a) selectively outputting the fully synchronized audio and video to a digital video interface.

55. The method of claim 51, further comprising:
a) selectively outputting the fully synchronized audio for input to an external analog audio device.

56. The method of claim 51, further comprising:
a) selectively outputting the fully synchronized audio for input to an external digital audio device.

57. A fully synchronized audio/video input system for use with computers, comprising:
a) an optional video input having a first plurality of associated video input clock signals for communicating video information;
b) an optional audio input having a first plurality of associated audio input clock signals for communicating audio information;
c) a frame buffer memory, coupled to the optional audio input and capable of storing video frames received from the optional video input, wherein video frames are stored within and retrieved from the frame buffer memory on a first in, first out (FIFO) basis;
d) a computer interface, adapted to interface to a computer and coupled to the frame buffer memory; and
e) a clock synchronization system adapted to receive the first plurality of video and audio input clock signals, wherein the clock synchronization system generates a second plurality of video and audio clock signals used internally by the input system to store audio and video information within the frame buffer memory;
wherein the input system generates fully synchronized audio and video at selected video frame rates, and wherein the selected video frame rates exceed 60 Hz.

58. The fully synchronized audio/video input system of claim 57, wherein the selected video frame rates comprise 72 fps and 75 fps video frame rates.

59. The fully synchronized audio/video input system of claim 57, further comprising:
a) a color space transformation (CST) block operatively coupled to the optional video input, wherein the CST block optionally converts video from a first color space representation to a second color space representation.

60. A fully synchronized audio/video display system capable of displaying fully synchronized video on computer-compatible display monitors, comprising:
a) an optional video input/output (I/O) having a first plurality of associated video clock signals for communicating video information;
b) an optional audio I/O having a first plurality of associated audio clock signals for communicating audio information;
c) a frame buffer memory, coupled to the optional audio I/O and responsive to the video I/O, wherein video frames are stored within and retrieved from the frame buffer memory on a first in, first out (FIFO) basis;
d) a computer interface, adapted to interface to a computer and coupled to the frame buffer memory; and
e) a clock synchronization system adapted to receive the first plurality of video and audio clock signals, wherein the clock synchronization system generates a second plurality of video and audio clock signals used internally by the display system to retrieve audio and video information stored within the frame buffer memory;
wherein the display system generates fully synchronized audio and video at selected frame rates, and wherein the selected frame rates exceed 60 Hz.

61. The system of claim 60, wherein the display system selectively outputs the fully synchronized audio and video for display on 72 Hz and 75 Hz computer-compatible monitors.

62. The system of claim 60, wherein the display system selectively outputs the fully synchronized audio and video to a digital video interface.

63. The system of claim 60, wherein the display system selectively outputs the fully synchronized audio for input to an external analog audio device.

64. The system of claim 60, wherein the display system selectively outputs the fully synchronized audio for input to an external digital audio device.

65. The fully synchronized audio/video display system of claim 60, further comprising:
a) a color space transformation (CST) block operatively coupled to the optional video I/O, wherein the CST block optionally converts video from a first color space representation to a second color space representation.

66. The system of claim 31, wherein the SMPTE 292M standard for HDTV bit-serial interfaces includes a blanking interval, and wherein unused data bandwidth available within the blanking interval is used to transmit the digital video with increased resolution.

67. The system of claim 66, wherein the increased resolution digital video comprises 2560 (horizontal) by 1080 (vertical) digital video.

68. The system of claim 66, wherein the increased resolution digital video comprises 2048 (horizontal) by 1280 (vertical) digital video.
